(19) United States
(12) Patent Application Publication
(10) Pub. No.: US 2004/0133405 A1
(43) Pub. Date: Jul. 8, 2004

(54) [SYSTEM AND METHOD FOR LIQUID CRYSTAL DISPLAY MODULE DESIGN]

(76) Inventors: Chuen-Ru Lee, Taoyuan (TW); Szu Fen Chen, Taoyuan (TW); Sheng-Hsiung Hou, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,270

(22) Filed: Jul. 8, 2003

(30) Foreign Application Priority Data
Dec. 18, 2002 (TW) 91136480

(51) Int. Cl. G06F 17/10

(52) U.S. Cl. 703/2

(57) ABSTRACT

A method and system for designing a liquid crystal display device is provided. The method and system include the following steps. They are: based upon at least one viewing angle among a plurality of liquid crystal display films, determine a range of a gap between liquid crystal cells of a liquid crystal display device; based upon the panel transmittance and gamut of a plurality of liquid crystal modules, determine at least one value of the gap between liquid crystal cells of the liquid crystal display device; based upon optic characteristics of a plurality of color filter films and color modules, determine a set of optic characteristics for a color filter as well as for the liquid crystal display device; and adjusting values related to the set of optic characteristics of the liquid crystal display device and the color filter. Thereby a set of adjusted values for present as well as future design purposes is produced.

### CROSS REFERENCE TO RELATED APPLICATIONS

This application claims the priority benefit of Taiwan application serial no. 91136480, filed Dec. 18, 2002.

### BACKGROUND OF INVENTION

1. Field of the Invention

The present invention relates to a system and methods for modeling design systems. More specifically, the present invention relates to system and method for liquid crystal display module design.

2. Description of the Background Art

Liquid crystal displays (LCDs) are gaining in popularity for use in systems such as television receivers, computer monitors, avionics displays, aerospace displays, and other military-related displays. Liquid crystal displays are small in dimension, light in weight, and requires less power for driving the same. From everyday use to high-level industrial applications, liquid crystal displays are gradually taking the place where cathode ray tubes are being used.

In the development of a new liquid crystal display device, it is known to initially collect market information for establishing module standards. A designer designs the shape of the liquid crystal display and the related structures associated therewith. The above shape design and its related structures limit the luminous intensity of the back light source. The luminous intensity is related to the optic characteristics of the front panel and its related parameters. Furthermore, in the later stages of development, the modules in the end product are produced based upon the luminous intensity and the related parameters of the front panel surface. The end product is further tested. Based upon the test, further corrections may be performed

However, the above method requires the end product to be produced first or a finished product before any test or corrections can be performed thereon. Thus, it is time-consuming and increases the cost of the design process.

As can be seen, there is a need for an improved system and methods wherein liquid crystal module design can be efficiently performed. In addition, there's also a need for an improved the system and methods wherein various optic characteristics of the liquid crystal display module can be estimated with confidence for design purposes.

### SUMMARY OF INVENTION

In the present invention a method and system for liquid crystal display design are provided for a more efficient and accurate end product.

Accordingly, a method for designing a liquid crystal display device is provided. The method includes the following steps. They are: based upon at least one viewing angle among a plurality of liquid crystal display films, determining a range of a gap between liquid crystal cells of a liquid crystal display device; based upon the surface transmittance and gamut of a plurality of liquid crystal modules, determining at least one value of the gap between liquid crystal cells of the liquid crystal display device; based upon optic characteristics of a plurality of color filter films and color modules, determining a set of optic characteristics for a color filter as well as for the liquid crystal display device; and adjusting values related to the set of optic characteristics of the liquid crystal display device and the color filter. Thereby a set of adjusted values for present as well as future design purposes is produced.

Accordingly, a method for designing a liquid crystal display module suitable for developing a system for designing a product is provided. The system includes a database, wherein color characteristic parameters relating to a plurality of liquid crystal film, to a plurality of color filter film, to a plurality of testing modules, and to a plurality of standard module are stored therein. The method includes the following steps. They are: based upon data relating to a plurality of liquid crystal cell gaps and their respective viewing angle, provide an expression of the relationships between the viewing angles and cell gaps, and deriving a range of the cell gaps; based upon data relating to a plurality of panel surfaces transmittance and their respective color gamut, provide an expression of the relationships between the plurality of surfaces transmittance and their respective color gamut, and deriving at least one cell gap value; based upon data relating to the plurality of color filter films and testing modules, provide a set of expressions of relationships including the relationship of color filter film thickness with color filter characteristics, the relationship of color filter characteristics with liquid crystal testing module, and determining color filter standard and product standard based upon the above relationship; and correct product color characteristics based upon the ratio of measured value with modeling value.

Accordingly, a system for designing a liquid crystal module for designing a prototype of a product is provided. The system includes means for performing a method comprising the following steps. They are: based upon at least one viewing angle among a plurality of liquid crystal display films, determining a range of a gap between liquid crystal cells of a liquid crystal display device; based upon the surface transmittance and gamut of a plurality of liquid crystal modules, determining at least one value of the gap between liquid crystal cells of the liquid crystal display device; based upon optic characteristics of a plurality of color filter films and color modules, determining a set of optic characteristics for a color filter as well as for the liquid crystal display device; and adjusting values related to the set of optic characteristics of the liquid crystal display device and the color filter. Thereby a set of adjusted values for present as well as future design purposes is produced.

Accordingly, a system for designing a liquid crystal module for designing a prototype of a product is provided. The system includes a database, wherein color characteristic parameters relating to a plurality of liquid crystal film, to a plurality of color filter film, to a plurality of testing modules, and to a plurality of standard module are stored therein. The system includes a method which includes the following steps: based upon data relating to a plurality of liquid crystal cell gaps and their respective viewing angle, providing an expression of the relationships between the viewing angles and cell gaps, and deriving a range of the cell gaps; based upon data relating to a plurality of panel surfaces transmittance and their respective color gamut, provide an expression of the relationships between the plurality of surfaces transmittance and their respective color gamut, and deriving at least one cell gap value; based upon data relating to the plurality of color filter films and testing modules, providing a set of expressions of relationships including the relationship of color filter film thickness with color filter characteristics, the relationship of color filter characteristics with liquid crystal testing module, and determining color filter standard and product standard based upon the above relationship; and correct product color characteristics based upon the ratio of measured value with modeling value.

These and other features, aspects and advantages of the present invention will become better understood with reference to the following drawings, description and claims.

### BRIEF DESCRIPTION OF DRAWINGS

FIG. 1 shows driving a first set of values of the instant invention using trendline regression.

FIG. 2 shows driving a second set of values of the instant invention using trendline regression.

FIG. 3 shows driving a third set of values of the instant invention using trendline regression.

FIG. 4 is a first Table listing a first set of values of the instant invention.

FIG. 5 is a second Table listing a second set of values of the instant invention.

FIG. 6 is a third Table listing a third set of values of the instant invention.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

When designing a machine or product involving liquid crystal display, a designer may be required to collect market information or client requirements in order to establish a module standard. A module standard is anything that the market requires or a client wants. Furthermore, the designer starts the optic design phase, wherein liquid crystal cell gap is determined. The optic design phase further includes the dissemination of color filter optic characteristics, end product color filter optic characteristics, and other related optic characteristics. Furthermore, the results of the above optic design needs to satisfy some basic design requirements. The following is an embodiment of the present invention which lists in detail a system and methods for liquid crystal display module design.

It is assumed that the design requirements are predetermined. For example, the following elements are predetermined, they include end product or resultant device (15″ SXGA⁺); luminous intensity (150 nits); back light luminous intensity of the module (1500 nits); color gamut (>45% NTSC ratio); and viewing angle (±45 degrees horizontal, 10 to 30 degrees vertical). Furthermore, based on the luminous intensity and the backlight luminous intensity, surface transmittance is determined to be greater than 10 percent (≧10%).

A database including a subset of databases needs to be established. The subset of databases includes liquid crystal cell database, color filter database, testing module database, and standard module for design calibration related database. The values (of data) of the above databases are determined based on measurements of the various optic characteristics related to the design. Further, the above values can be derived from either modeling or computation. However, if the database does not include the data needed for design purposes, data needs to be derived or somehow retrieved and stored in the database.

Furthermore, new product development needs to be based on a standard that is known. Usually this standard is the based upon known products. In this embodiment, the known product possess a series No. 15″ XGA.

Determining the Range of the Cell Gap

Initially the range of the cell gap needs to be determined. The liquid crystal cell gap is determined based upon the viewing angle. In other words, the above cell gap range is derived from any expression containing elements that includes viewing angle and the distance between liquid crystal cells.

Referring to table 1, the liquid crystal film (Merck Liquid Crystal) having a 6 o'clock viewing angle is described. Listed in the table are the maximum values of various directions of the viewing angles. The viewing angle directions include 3′, 9″, 12″ and 6″. Also in table 1, the distance between liquid crystal cells is known. Furthermore, liquid crystal films having different intercellular distances may have their maximum viewing angle computed. Lastly, the above measured values data may be stored in their liquid crystal cell database.

TABLE 1
(6 o'clock viewing angle)

| | Direction of | Direction of | Direction of | Direction of |
|---|---|---|---|---|
| | viewing | viewing | viewing | viewing |
| Inter-distance | angle | angle | angle | angle |
| (μm) | (3′) | (9′) | (12′) | (6′) |
| 3.939 | 53 | 53 | 27 | >60 |
| 4.435 | 45 | 48 | 26 | >60 |
| 5.745 | 46 | 44 | 20 | >60 |
| Relationship | y = | y = | y = | y = 60 |
| between | −2.9765x + | −4.6499x + | −4.0663x + | |
| viewing angle | 61.989 | 70.168 | 43.444 | |
| and d_{g} | | | | |

Furthermore, as shown in table 1, the relationship between the viewing angle and inter-distance are established based on data stored within the liquid crystal cell database. The above relationship can be expressed using trend line regression method. In turn, the viewing angle characteristics are inserted into the above relationship and the gap values are derived as shown in Table 2. This way, it can be seen that the gap between liquid crystal cells determines the range of the inter-distances. In this case, that the derived distance range is greater than 3.93 micrometer and the less than 5.4 micrometer.

TABLE 2

| | Direction of | Direction of | Direction of | Direction of |
|---|---|---|---|---|
| | viewing | viewing | viewing | viewing |
| | angle | angle | angle | angle |
| | (3′) | (9′) | (12′) | (6′) |
| Viewing angle | 45 | 45 | 10 | 30 |
| Gap (d_{g} μm) | <5.705 | <5.415 | <8.224 | >3.93 |

It should be noted that the three films of table 1 should not be a limitation to the instant invention. A suitable number of films may be used to derive the relationship between the inter-distance and the viewing angle. Furthermore, the liquid crystal material used should not be limited series Merck fast Liquid Crystal series. In fact, by measuring different types of liquid crystal cells, a sub database may be set up having data related to different types stored therein. Thus, relationships of optic characteristics of a plurality of the different types of liquid crystal may be stored in a database for current or future use.

Determines the Values of Cell Gap

Open establishing the range of the cell gap, the value of the cell gap can be determined. The determination is based upon the panel transmittance rate T (%) in relationship to design purposes. In other words, the selection of the cell gap for an optic design system is based upon a selection among a plurality of panels each having its own panel transmittance rate T (%). The panel transmittance rate T is further compared with the light or optic characteristics (for example gamut) for the determination of the cell gap.

In the present embodiment, the relationship between the panel transmittance rate T and the optic characteristics (gamut G) is established as follows.

Referring to Tables 3-5, three different modules each having different optic characteristics are shown. It is noted that the two important values in the Tables are module color coordinate values (white light grey gradient) and module color gamut G. Furthermore, Tables 3-5 list a set of measured values of the three different modules S1, S2, S3, each relating to its own color filter film. Furthermore, the measured values may be stored in the module database for present or future use.

TABLE 3
dᵣ₁ = 0.76, d_{g1} = 0.79, d_{b1} = 0.83 (μm)

| S1 | Red | Green | Blue | White | Gamut |
|---|---|---|---|---|---|
| x | 0.4930 | 0.3409 | 0.1713 | 0.3099 | |
| y | 0.3253 | 0.5423 | 0.1818 | 0.3421 | 28.96% |
| Y | 2.3690 | 5.4465 | 2.2115 | 9.9448 | |

TABLE 4
dᵣ₂ − 1.14, d_{g2} − 1.22, d _{b2} − 1.19 (μm)

| S2 | Red | Green | Blue | White | Gamut |
|---|---|---|---|---|---|
| x | 0.5566 | 0.3323 | 0.1586 | 0.3107 | |
| y | 0.3298 | 0.5781 | 0.1478 | 0.3388 | 44.14% |
| Y | 1.9032 | 4.9745 | 1.5931 | 8.4132 | |

TABLE 5
dᵣ₃ = 1.51, d_{g3} = 1.59, d_{b3} = 1.57 (μm)

| S3 | Red | Green | Blue | White | Gamut |
|---|---|---|---|---|---|
| x | 0.5969 | 0.3223 | 0.1522 | 0.3096 | |
| y | 0.3334 | 0.5998 | 0.1220 | 0.3340 | 55.79% |
| Y | 1.6611 | 4.6464 | 1.2087 | 7.4544 | |

Deriving Panel Transmittance Rate T and Transmittance Correction

The embodiment would now proceed to deriving the panel transmittance rate T which needs to be compensated in order to meet product requirements. The panel transmittance rate T after correction can be expressed as follows:

T(%)=Y*aperture ratio correction*liquid crystal gap correction*computed value vs. measured value correction (1).

Wherein Y represents optic characteristic coordinates, aperture ratio correction is the ratio between the device subject to designing (15″ SXGA⁺ model) and the standard or calibration device (15″ XGA model). liquid crystal gap correction is defined as the ratio of computed correction using T_{LC} and its corresponding measured value. Thereby an actual specific value is used for correction purposes. Further, the relationship between the liquid crystal transmittance and liquid crystal gap can be retrieved from liquid crystal sub-database. Further, the data in the above data base can be derived using trendline regression, and expressed as follows:

T_{LC}=−0.088 d_{g}²+0.1918 d_{g} 0.120 (2).

In the exemplified embodiment of a production line application, liquid crystal gap alternates between 4.3 micrometer or 4.7 micrometer. Therefore, the correction values are either 4.3 micrometer or 4.7 micrometer. Further, the correction is expressed as the ratio between computed and measured values. Specifically, the ratio is expressed as the ratio between the transmittance of the standard module and the transmittance of the modeled module.

Upon supplanting the above values into equation (1), as shown in Table 6, transmittance rate can be computed for modules S1, S2, and S3 at 4.3 μm and 4.7 μm respectively.

TABLE 6

| | T (4.3 μm, %) | T (4.7 μm, %) |
|---|---|---|
| S1 | 11.18 | 11.46 |
| S2 | 9.44 | 9.68 |
| S3 | 8.38 | 8.59 |

From Tables 3-5, take the values of G, and from Table 6, take the value T, we can arrive at a relationship between T and G. This can be achieved using the trendline regression method as shown in equations (3) and (4).

T(4.3 μm)=−0.1048G+14.172 (3).

T(4.7 μm)=−0.1075G +14.53 (4).

Based upon the above equations (3) and (4), insert the design requirement into the same. For G=45% we have: T (4.3 μm)=9.456<10%, T (4.7 μm)=9.693<10%.

Further, when transmittance is 10%, T (gap=4.3 μm)>10%, Gamut=42%; T (gap=4.7 μm)>10%, Gamut=39%.

Based upon the above, it is more advantageous to have gap value equal to 4.7 micrometer.

Upon the determination of the gap value, we further compute values of the color filter film and other optic characteristics of the device or product. The characteristic of the color filter film and other optic characteristics of the product are derived from color filter film thickness. The film thickness posseses a relationship with color filter characteristics, as well as the relationship of the color filter characteristic in relation with the x, y, Y parameters of the same.

The above relationships are established as follows. First, data are retrieved from color filter sub database. The data include data pertaining to three different films having different thickness d. The testing film″s optic characteristics are expressed as xc yc Yc. The testing module″s optic characteristics are expressed as xm, ym Ym which may be obtained from testing module sub database. The above values of d, xc yc Yc, and xm, ym Ym are listed in Tables 7-9 according to color red (R), green (G) and blue (B).

TABLE 7
Red

| thickness | xc | yc | Yc | xm | ym | Ym |
|---|---|---|---|---|---|---|
| 0.76 | 0.507878 | 0.321983 | 31.89036 | 0.492969 | 0.325289 | 2.368973 |
| 1.14 | 0.571457 | 0.325483 | 25.83453 | 0.55663 | 0.329794 | 1.90318 |
| 1.51 | 0.612501 | 0.329361 | 22.68296 | 0.596945 | 0.33344 | 1.661083 |

TABLE 8
Green

| thickness | xc | yc | Yc | xm | ym | Ym |
|---|---|---|---|---|---|---|
| 0.79 | 0.531376 | 0.337974 | 70.89064 | 0.34092 | 0.542342 | 5.446514 |
| 1.22 | 0.566176 | 0.329048 | 64.74404 | 0.332261 | 0.578094 | 4.974489 |
| 1.59 | 0.586934 | 0.319926 | 59.82565 | 0.322311 | 0.599781 | 4.646388 |

TABLE 9
Blue

| thickness | xc | yc | Yc | xm | ym | Ym |
|---|---|---|---|---|---|---|
| 0.83 | 0.197406 | 0.159128 | 30.98312 | 0.191347 | 0.181832 | 2.211537 |
| 1.19 | 0.169549 | 0.144835 | 23.66457 | 0.158648 | 0.147816 | 1.593074 |
| 1.57 | 0.148295 | 0.138726 | 19.09801 | 0.15222 | 0.121971 | 1.208692 |

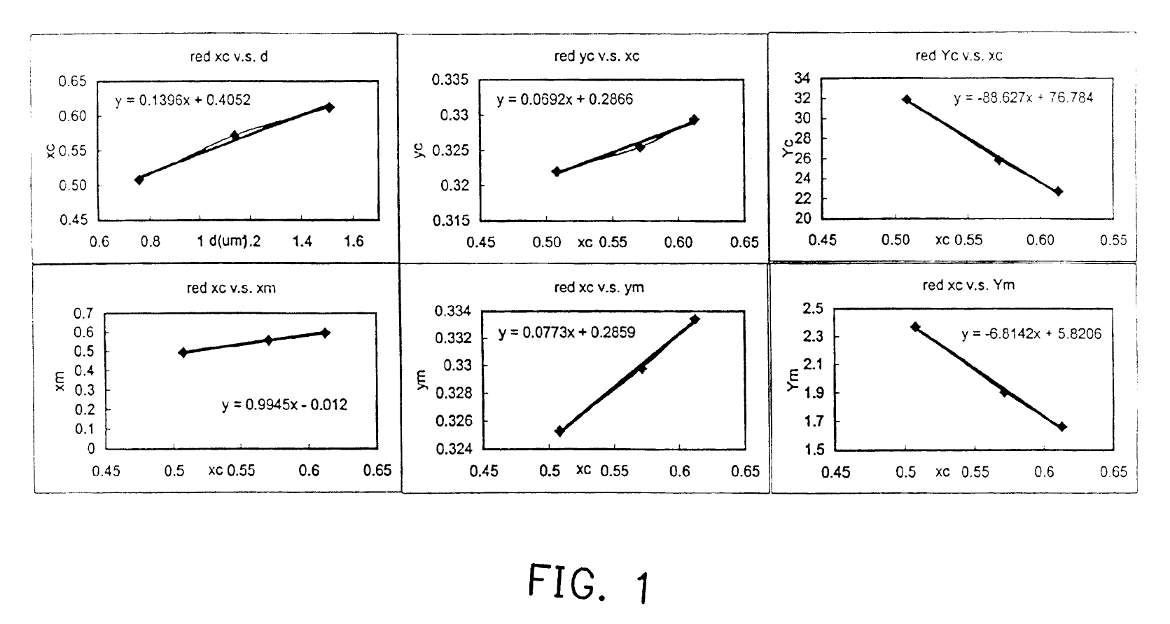

As can be appreciated, the relationship among color filter films″ thickness, testing module color characteristics, color filter″s x, y, Y can be derived using Table 7. In FIG. 1, the above relationships are established using trend line regression. Referring now to FIG. 1, the relationship between the red filter film and the d vs. xc, xc vs. yc, xc vs. Yc, xc vs. xm, xc vs. ym, and xc vs Ym are shown. Since color red is determined by xc, it is used as the starting point. Based on trendline regression, at least two points are needed for the regression.

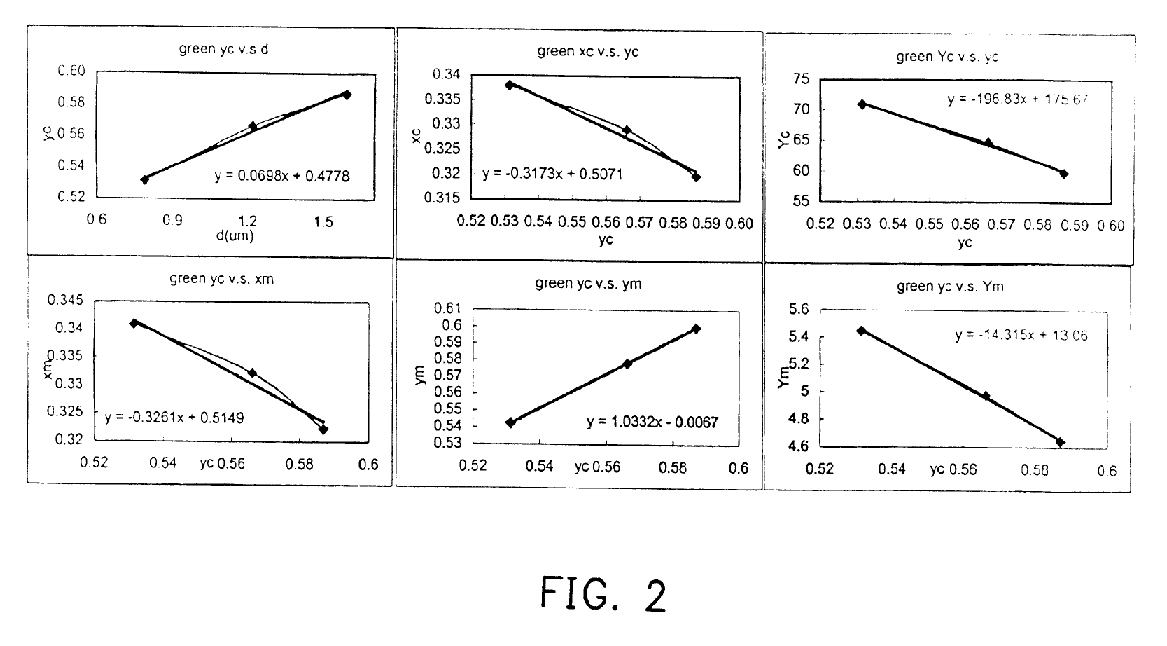

From Table 8, we arrive at FIG. 2. Referring to FIG. 2, the relationship of green yc vs. d, green xc vs. yc green Yc vs. yc, green yc vs. xm green yc vs. ym and green yc vs. Ym are shown. Since color green is determined by yc, it is used as the starting point.

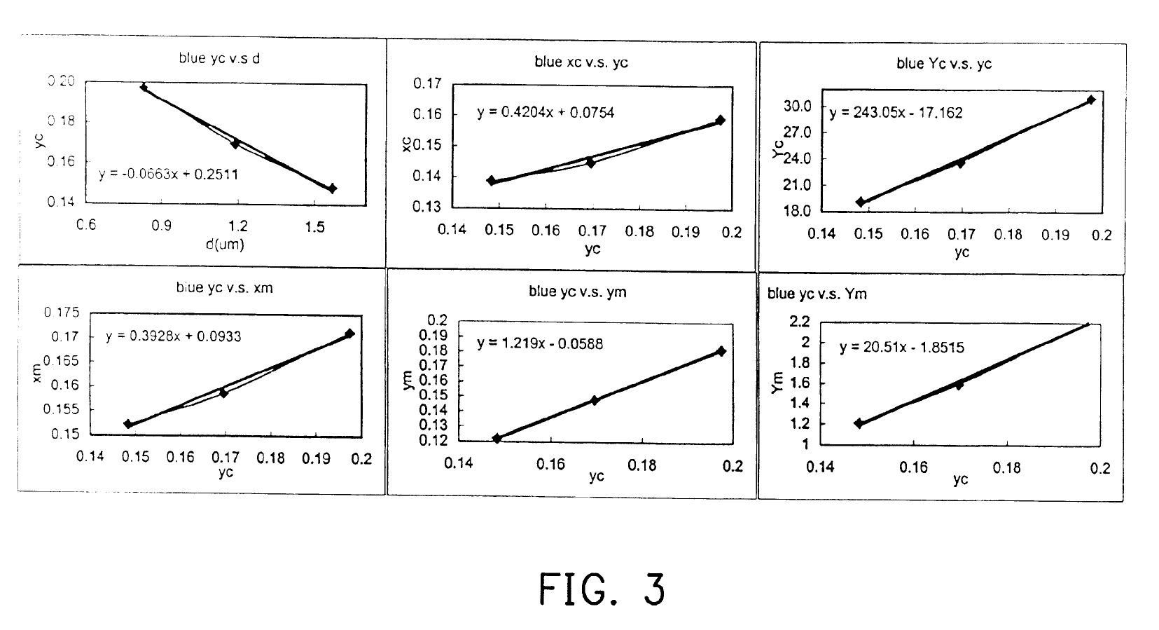

Similarly, from Table 9 to FIG. 3, we derive similar parameter relationships. And since color blue is determined by yc, it is used as the starting point.

Upon establishing the relationships based upon FIGS. 1-3 coupled with the requirement that color gamut be equal to 45%, the acceptable thickness should be between 1.1 to 1.3 μm. The device″s color characteristics are shown in Table 10.

TABLE 10

| CF standard | Red | Green | Blue | White | Gamut |
|---|---|---|---|---|---|
| d (μm) | 1.25 | 12.5 | 1.0 | | |
| xc | 0.5797 | 0.3278 | 0.1531 | 0.3084 | 43.43% |
| yc | 0.3267 | 0.5651 | 0.1848 | 0.3439 | |
| Yc | 25.41 | 64.45 | 27.75 | 39.20 | |

Modeled values of optic characteristics of the device

| | | | | | |
|---|---|---|---|---|---|
| xm | 0.5645 | 0.3306 | 0.1659 | 0.3076 | 43.18% |
| ym | 0.3307 | 0.5771 | 0.1665 | 0.3388 | |
| Ym | 1.870 | 4.971 | 1.939 | 8.780 | |

The values in Table 10 are the designing device″s color filter characteristics. However, the above values are required to be further corrected for reaching a final set of color filter characteristic data.

The requisite correction involves retrieving data from designing standard sub-database, as well as measured data. Designing standard data base may establish three types of standard test module.

(i) 15″ XGA front penal+ordinary upper and lower polarizing filter (exclusive of viewing angle compensation film (WV Film)+15″ backlight.

(ii) 15″ XGA front penal+ordinary upper polarizing filter+ordinary lower polarizing filter (exclusive of viewing angle compensation film (WV Film), but including DBEF+15″ backlight.

(iii) 15″ XGA front penal+ordinary upper polarizing filter+ordinary lower polarizing filter (exclusive of viewing angle compensation film (WV Film), but including PCF+15″ backlight.

The module values are computed based upon the structures of (i).

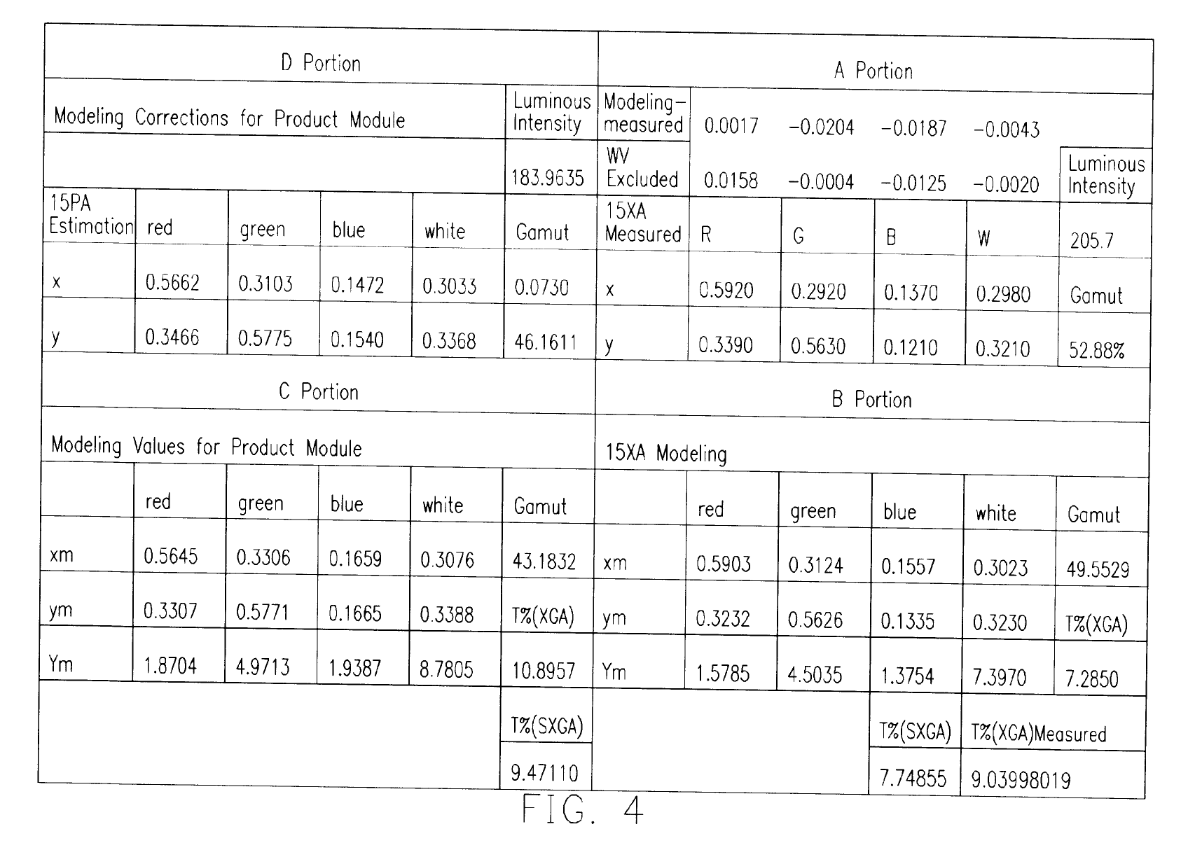

Referring now to FIG. 4, the measured values and the modeling values are provided in portion A and portion B respectively. Further, in portion C, product module″s optic characteristics are provided. A set of complete estimation values are derived from multiplying the ratio of the measured value of portion A to that of modeled value of portion B with the module optic characteristic value. The corrected values of transmittance (from XGA to SXGA⁺) is derived from opening ratio correction (from XGA=66.5% to SXGA⁺=57%). Furthermore, the complete estimation value of the luminous intensity is the product of factor 1 which is back light module and factor 2 which is SXGA⁺ transmittance. The corrected version is entered in portion D.

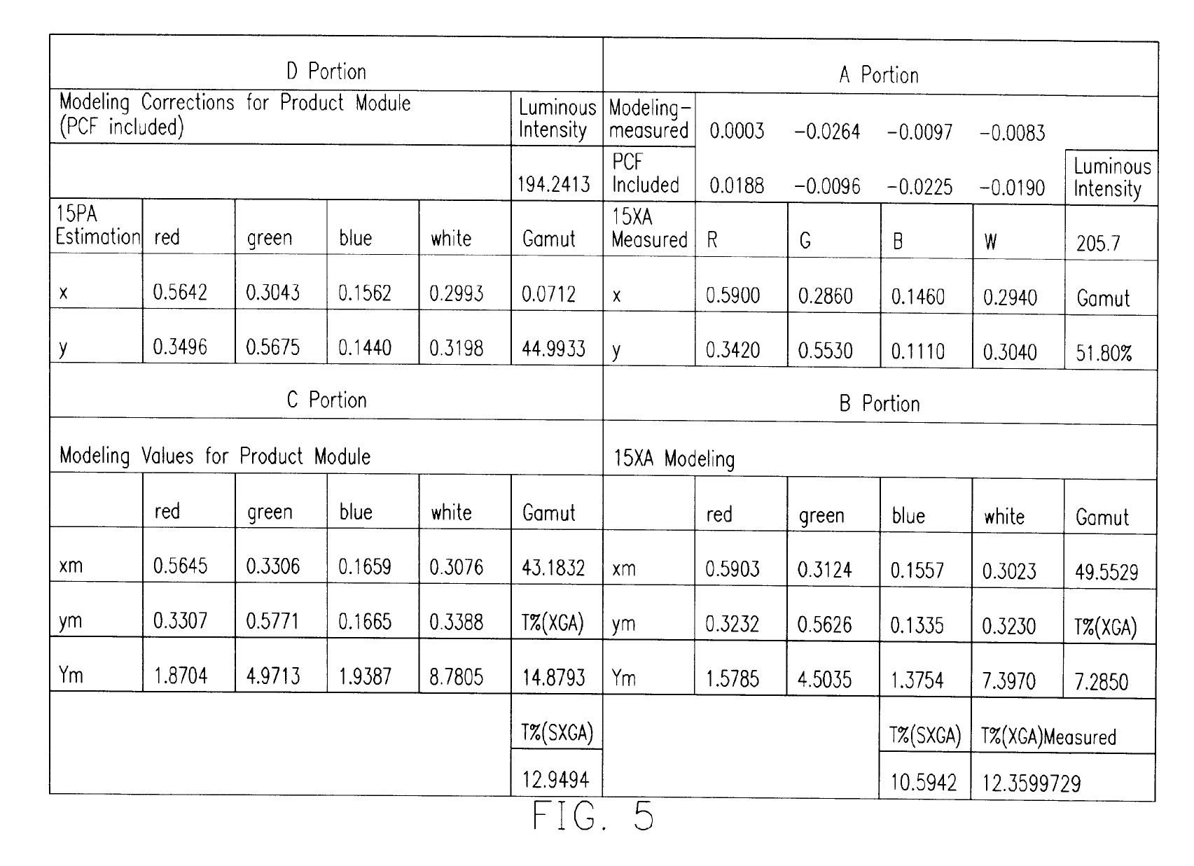

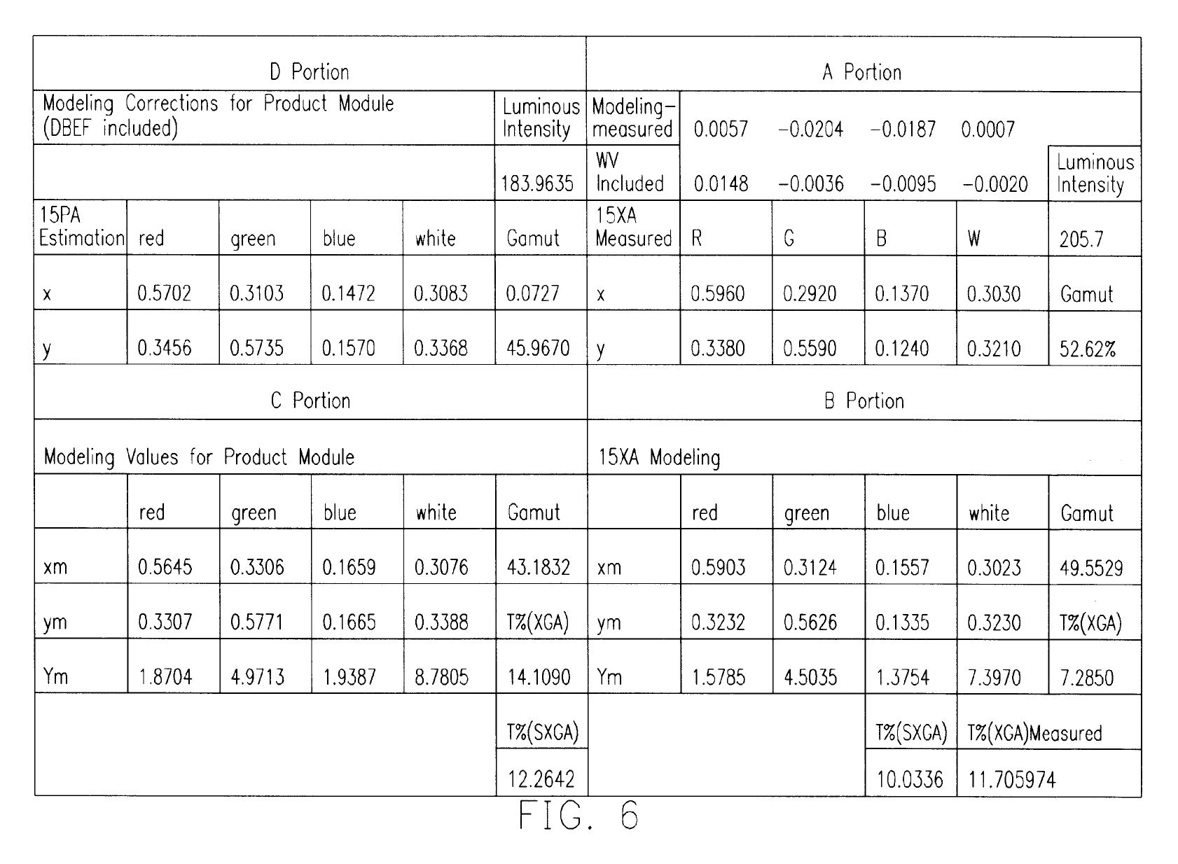

Furthermore, in FIG. 5, the portion D of the same is related to (ii), wherein DBEF (Deal Brightness Enhancement Film) is used. And in FIG. 6, portion D of the same is related to (iii), wherein PCF (Polarization Conversion Film) is used.

From FIGS. 4-6, it is known that using DBEF (FIG. 5) and PCF (FIG. 6) meets design requirements. Thereby the optic characteristic of the above meet the product's design requirement.

One embodiment of the invention is implemented as a program product for use with a computer system The program(s) of the program product defines functions of the embodiments and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In addition, it should be noted that the data in the databases described supra may not be complete. The incomplete data bases can be rendered more complete by the addition of relevant data thereto. Further, the instant invention contemplates using efficient means such as computer program to speed up the design process while at the same time maintain sufficient accuracy of the design parameters.

Color Gamut is defined as a value representing a whole range of color for a giving system. Gamut is an abbreviation of color gamut.

It should be understood, of course, that the foregoing relates to preferred embodiments of the invention and that modifications may be made without departing from the spirit and scope of the invention as set forth in the following claims.

1 A method for designing a liquid crystal display device, the method comprising the steps of:
based upon at least one viewing angle among a plurality of liquid crystal display films, determining a range of a gap between liquid crystal cells of a liquid crystal display device;
based upon the panel transmittance and gamut of a plurality of liquid crystal modules, determining at least one value of the gap between liquid crystal cells of the liquid crystal display device;
based upon optic characteristics of a plurality of color filter films and color modules, determining a set of optic characteristics for a color filter as well as for the liquid crystal display device; and
adjusting values related to the set of optic characteristics of the liquid crystal display device and the color filter, thereby producing a set of adjusted values for present as well as future design purposes.

2. The method of claim 1, wherein the range of the gap is determined using at least two values of the gaps of the plurality of liquid crystal display films along with the viewing angles corresponding thereto, thereby establishing a formula expressing the range using the values of the gaps and their corresponding viewing angles.

3. The method of claim 2, wherein the formula is obtained using trendline regression.

4. The method of claim 1, wherein the at least one value of the gap between liquid crystal cells of the liquid crystal display device is determined using the panel transmittance and gamut of a plurality of liquid crystal modules for establishing a plurality of relationships between the panel transmittance and the gamut therewith.

5. The method of claim 4, wherein the panel transmittance is defined as follows:
panel transmittance=Y * aperture ratio correction * gap of liquid crystal cell correction * measured value correction,
where Y denotes optic characteristic co-ordinate values;
aperture ratio correction is defined as the ratio of product or device aperture rate with the standard module opening rate; and the gap of liquid crystal is derived using a predetermined gap value and equation (2).

6 The method of claim 4, wherein the relationship between the panel transmittance and the gamut is determined by trendline regression.

7. The method of claim 1, wherein the optic characteristics of the module are determined by color filter film thickness.

8. The method of claim 7, wherein the optic characteristics of the module are derived using trendline regression.

9. The method of claim 1, wherein the optic characteristics include a set of products, wherein each product has factor one which is the ratio of measured value with modeled value and factor two which is a correction of the optic characteristics.

10. The method of claim 1, wherein the color module includes liquid crystal film and color filter film.

11. A method for designing a liquid crystal display module suitable for developing a system for designing a product, the system includes a database, wherein color characteristic parameters relating to a plurality of liquid crystal film, to a plurality of color filter film, to a plurality of testing modules, and to a plurality of standard module are stored therein, the method comprising the steps of:
based upon data relating to a plurality of liquid crystal cell gaps and their respective viewing angle, providing an expression of the relationships between the viewing angles and cell gaps, and deriving a range of the cell gaps
based upon data relating to a plurality of panel transmittance and their respective color gamut, providing an expression of the relationships between the plurality of panel transmittance and their respective color gamut, and deriving at least one cell gap value;
based upon data relating to the plurality of color filter films and testing modules, providing a set of expressions of relationships including the relationship of color filter film thickness with color filter characteristics, the relationship of color filter characteristics with liquid crystal testing module, and determining color filter standard and product standard based upon the above relationship; and
correcting product color characteristics based upon the ratio of measured value with modeling value.

12 The method of claim 11, wherein the testing module includes at least one liquid crystal film and a set of color filter films.

13. The method of claim 11, wherein the expression of the relationships between the viewing angles and cell gaps are expressed using trend line regression.

14. The method of claim 11, wherein the panel transmittance is defined as follows:
panel transmittance=Y * aperture ratio correction * gap of liquid crystal cell correction * measured value correction,
where Y denotes optic characteristic co-ordinate values;
aperture ratio correction is defined as the ratio of product or device aperture rate with the standard module opening rate; and the gap of liquid crystal is derived using a predetermined gap value and equation (2).

15. The method of claim 11, wherein the relationship between the panel transmittance and the gamut is determined by trendline regression.

16. The method of claim 11, wherein the expressions of relationship is derived using trendline regression.

17. A system for designing a liquid crystal module for designing a prototype of a product, the system includes means for performing a method comprising the following steps:
based upon at least one viewing angle among a plurality of liquid crystal display films, determining a range of a gap between liquid crystal cells of a liquid crystal display device;
based upon the panel transmittance and gamut of a plurality of liquid crystal modules, determining at least one value of the gap between liquid crystal cells of the liquid crystal display device;
based upon optic characteristics of a plurality of color filter films and color modules, determining a set of optic characteristics for a color filter as well as for the liquid crystal display device; and
adjusting values related to the set of optic characteristics of the liquid crystal display device and the color filter, thereby producing a set of adjusted values for present as well as future design purposes.

18. The system of claim 17, wherein the steps of the method are implemented using a computer program.

19. A system for designing a liquid crystal module for designing a prototype of a product, the system includes a data base, wherein color characteristic parameters relating to a plurality of liquid crystal film, to a plurality of color filter film, to a plurality of testing modules, and to a plurality of standard module are stored therein, the system includes a method comprising the steps of:
based upon data relating to a plurality of liquid crystal cell gaps and their respective viewing angle, providing an expression of the relationships between the viewing angles and cell gaps, and deriving a range of the cell gaps;
based upon data relating to a plurality of panel transmittance and their respective color gamut, providing an expression of the relationships between the plurality of panel transmittance and their respective color gamut, and deriving at least one cell gap value;
based upon data relating to the plurality of color filter films and testing modules, providing a set of expressions of relationships including the relationship of color filter film thickness with color filter characteristics, the relationship of color filter characteristics with liquid crystal testing module, and determining color filter standard and product standard based upon the above relationship; and
correcting product color characteristics based upon the ratio of measured value with modeling value.

20. The system of claim 19, wherein a computer program is used to perform the steps.
